(19) United States
(12) Patent Application Publication
(10) Pub. No.: US 2013/0099615 A1
(43) Pub. Date: Apr. 25, 2013

(54) MAGNETIC TORQUE SYSTEMS

(71) Applicant: Lynwood A. Stewart, Kent, WA (US)

(72) Inventor: Lynwood A. Stewart, Kent, WA (US)

(21) Appl. No.: 13/659,860

(22) Filed: Oct. 24, 2012

Related U.S. Application Data
(60) Provisional application No. 61/551,276, filed on Oct. 25, 2011.

(51) Int. Cl. H02K 49/10

(52) U.S. Cl. 310/101

(57) ABSTRACT

A magnetic continuously variable-range transmission exemplifying a continuously variable magnetic torque transmission system using a magnetically patterned cone and magnetically engaged drive gears that are positionable parallel to the cone's surface using actuators. The actuators are responsive to a controller. By changing the position of the magnetic drive gears, the effective gear ratio changes smoothly between the maximum and minimum gear ratios for the particular embodiment. The magnetic drive gears are mechanically coupled to planetary gears that drive a sun gear which drives the output shaft. The cone may be patterned with magnets in such a way as to create a constant-torque transmission. The magnets in the pattern are placed, printed, or impressed, in a non-magnetic matrix.

### RELATED APPLICATIONS

This application claims the benefit of U.S. provisional patent application 61/551,276 filed Oct. 25, 2012 by the same inventor.

### FIELD OF THE INVENTION

The invention relates to torque transfer between two or more rotating bodies without direct contact and having segmented peripheral magnets on the rotating bodies. The invention further relates to an exemplary magnetic transmission.

### BACKGROUND

Advances in magnetic materials make new magnetic devices possible including the exemplary transmission described herein. A transmission is a device that transfers motion from an input, with a given torque and speed, to an output, with a different torque and speed. Traditional transmissions use a series of gears to provide this function. Typical examples of this are in the auto and truck industries where you have a 1^{st}, 2^{nd}, 3^{rd}, . . . gear and you shift between them.

### OBJECTS AND FEATURES OF THE INVENTION

A primary object and feature of the present invention is to provide torque transfer between first and second rotating bodies with peripheral magnetic patterns (segmented, printed, or impressed) that are proximate one another but not in direct contact, such that the magnetic fields of the first body, having driven rotation, will engage the magnetic fields of a loaded second rotatable body to cause the second body to rotate. Another object and feature of the present invention is to provide a magnetic torque system that functions as a transmission. Another object and feature of the present invention is to provide a magnetic torque system that functions as a continuous variable range transmission (CVT).

### BRIEF SUMMARY OF THE INVENTION

The purpose of the exemplary transmission of the present invention is to provide a continuous variable range of input-output gear ratios, or a continuous variable-range transmission (CVT), which can be adapted to individual applications. Using magnets as an integral part of this magnetic continuous variable-range transmission (MCVT) provides a unique set of properties when compared to currently available transmissions. These include non-contact, reduced lubrication, reduced complexity, reduced mechanical power loss, and reduced size.

An example of a transmission design and components is presented. Conic transmissions using belts are known. What is new here is the use of magnets rather than belts to transmit the torque and vary the speed. The conversion, via magnetic torque transfer mechanisms, or magnetic gears, from conic motion to axial motion is also new.

### BRIEF DESCRIPTION OF THE DRAWINGS

The above and other objects and advantages of the present invention will become more apparent from the following description taken in conjunction with the following drawings in which:

FIG. 1 is a perspective view illustrating an exemplary drive shaft and an exemplary magnetic torque cone of the exemplary Magnetic Continuously Variable-Range Transmission, according to an exemplary embodiment of the present invention;

FIG. 2 is a perspective view illustrating an exemplary drive shaft and an exemplary magnetic torque cone of FIG. 1 with spline shafts, gear carriages, and magnetic gears of the exemplary Magnetic Continuously Variable-Range Transmission of FIG. 1, according to an exemplary embodiment of the present invention;

FIG. 3 is a perspective view illustrating an exemplary drive shaft and an exemplary magnetic torque cone of FIG. 1; with spline shafts, gear carriages, and magnetic gears of FIG. 2; and gear carriage drivers and carriage drive shafts of the exemplary Magnetic Continuously Variable-Range Transmission of FIG. 1; as well as output magnetic planetary gears and output drive shaft, according to an exemplary embodiment of the present invention;

FIG. 4 is a perspective view illustrating a detail of an exemplary planetary magnetic gear arrangement of the exemplary Magnetic Continuously Variable-Range Transmission of FIG. 1, according to an exemplary embodiment of the present invention;

FIG. 5 is a shaded perspective view illustrating the exemplary Magnetic Continuously Variable-Range Transmission of FIG. 1, according to an exemplary embodiment of the present invention;

FIG. 6 is a top plan wire-frame view illustrating the exemplary Magnetic Continuously Variable-Range Transmission of FIG. 1, according to an exemplary embodiment of the present invention;

FIG. 7 is a bottom plan shaded view illustrating the exemplary Magnetic Continuously Variable-Range Transmission of FIG. 1, according to an exemplary embodiment of the present invention;

FIG. 8 is a side elevation wire-frame view illustrating the exemplary Magnetic Continuously Variable-Range Transmission of FIG. 1, according to an exemplary embodiment of the present invention; and

FIG. 9 is a side elevation shaded view illustrating the exemplary Magnetic Continuously Variable-Range Transmission of FIG. 1, according to an exemplary embodiment of the present invention.

### DETAILED DESCRIPTION OF A PREFERRED EMBODIMENT

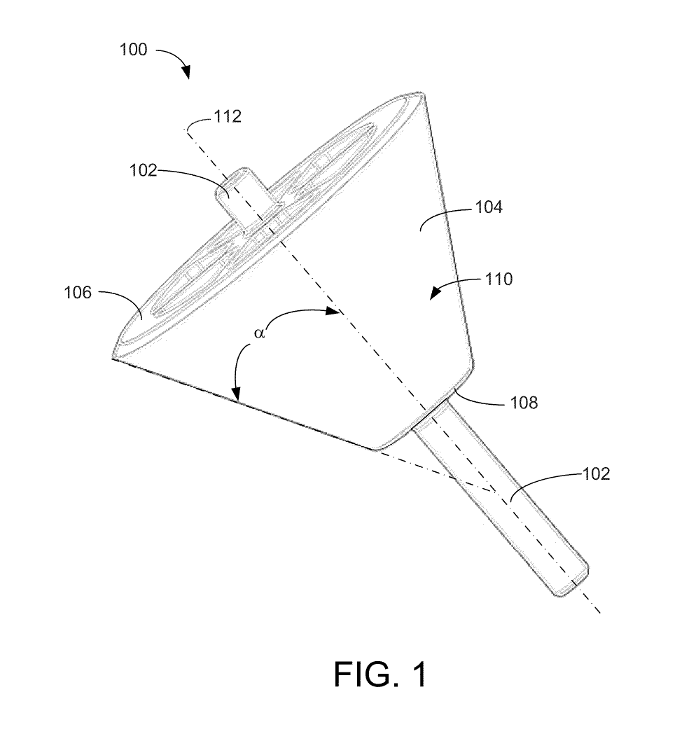

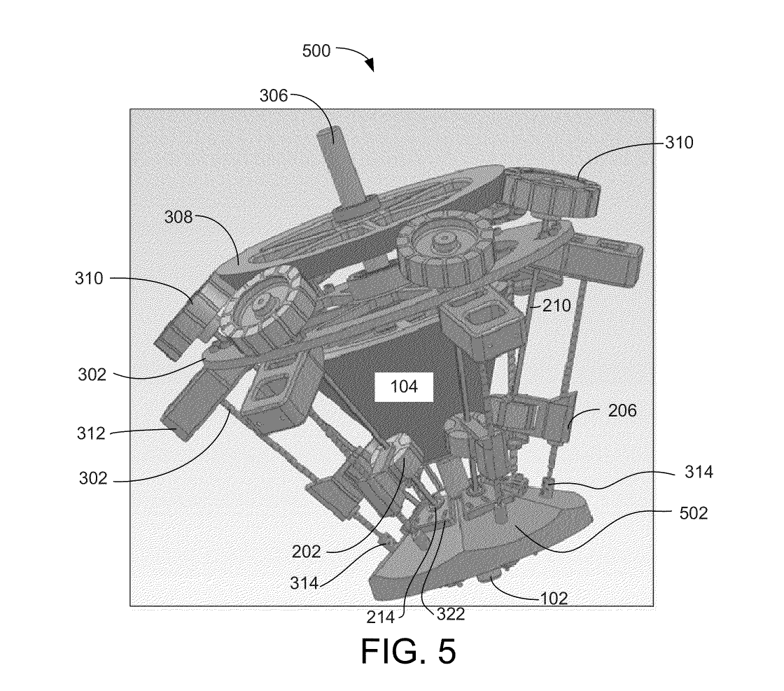

FIG. 1 is a perspective view illustrating an exemplary input drive shaft 102 and an exemplary magnetic torque cone 104 of the exemplary Magnetic Continuously Variable-Range Transmission 500 (See FIG. 5), according to an exemplary embodiment 100 of the present invention. Magnetic torque cone 104 is illustrated as a frustrum of a right circular cone fixed to input drive shaft 102 that rotates with the input drive shaft 102. Magnetic torque cone 104 comprises base plate 106, frustro-conical surface 110, and apex plate 108. Internal support structures of various kinds may be used within magnetic torque cone 104. At least base plate 106 and apex plate 108 support conical surface 110. Conical surface 110 comprises magnets (not shown), which may be discrete elements in a non-magnetic material or impressed on a magnetic material, or printed on a non-magnetic material. Patterning of the magnets may be made according to the application. For example, patterns include rectangular, tri-pitch (highest density), and spiral. A high-density pattern on the narrow end of the cone tapering to a lower density pattern at the wide end of the cone, adapted to the particular cone angle α, produces a constant-torque transmission, useful in particular installations.

The cone angle α, between the cone surface 110 and the central axis 112, can vary from small angles (typically less than 10 degrees) to a flat plate (90 degrees), from embodiment to embodiment. Particular embodiments may have particular cone angles α, but the cone angle α is constant in each particular embodiment.

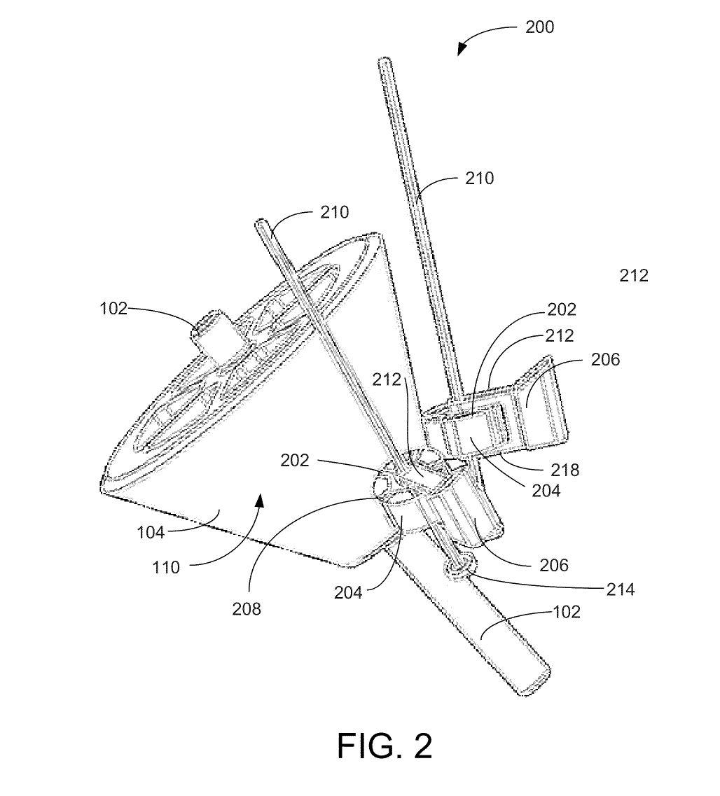

FIG. 2 is a perspective view illustrating an exemplary input drive shaft 102 and an exemplary magnetic torque cone 104 of FIG. 1 with spline shafts 210, gear carriages 206, and magnetic drive gears 202 of the exemplary Magnetic Continuously Variable-Range Transmission 500 (see FIG. 5) of FIG. 1, according to an exemplary embodiment 200 of the present invention. Spline shafts 210 are parallel to the surface 110 of the magnetic torque cone 104 and are supported in bearings 214 (one visible in this view). Magnetic drive gears 202 are operable to move axially along spline shafts 210 and rotation of the magnetic drive gears 202 force the spline shafts 210 to rotate. Magnetic drive gears 202 are not in contact with the conical surface 110. The rotation of the magnetic torque cone 104 magnetically drives the magnetic drive gears 202 to rotate the spline shafts 210. Axial movement of the magnetic drive gears 202 is assisted by the gear carriages 206 which each have an upper arm 212 and a lower arm 218 that have bearings, preferably magnetic, that allow rotation of the magnetic drive gears 202 and also may be actuated, as discussed below, to move the magnetic drive gears 202 axially along the spline shafts 210. Each magnetic drive gear 202 preferably has a structure 208 supporting magnetic segments 204. In an alternate embodiment, a magnetic pattern may be impressed on a magnetic material.

The magnetic drive gears 202 rotate responsively to the rotating magnetic fields of the magnetic torque cone 104. Because the torque is transmitted without contact there is no wear or friction at the gear interface. The “gear ratios” are determined by the diameter of the magnetic torque cone 104 with respect to the cone angle α and magnetic drive gears 202 at a specific axial position along the spline shafts 210. The number of magnetic drive gears 202 multiplied by the magnetic force available yields the total force available for torque and speed transmission.

The magnetic elements 204 in the magnetic drive gear 202 and magnetic torque cone 104 may be of Magnet-Magnet (MM), Magnet-Steel (MS), or Steel-Magnet-Steel (SMS). The actual materials are not specified here, as they are not the goal of the patent, but what is disclosed is that by providing different configurations of material and geometry the magnetic fields can be optimized for the task of rotating the magnetic drive gears 202 with the desired force.

That rotation of the magnetic torque cone 104 imparts force onto the magnetic drive gear 202 which rotates the magnetic drive gear 202 and the spline shaft 210 that is locked into rotation with the magnetic drive gear 202. Moving the magnetic drive gear 202 axially along the spline shaft 210 will change the speed of rotation of the spline shafts 210 and the torque output produced. The spline shaft 210 and associated mechanical interfaces 212, 214, and 218 may require lubrication.

A wide variety of arrangements of magnets on the cone surface 110 may be used. In a particular embodiment, the density of the magnets per square centimeter on the cone surface 110 increases toward the base of the cone 104 to provide a constant-torque transmission, which maintains a substantially constant torque regardless of speed or position of the magnetic drive gears 202. A constant-torque transmission is impossible with toothed-gears and is novel aspect of the present invention.

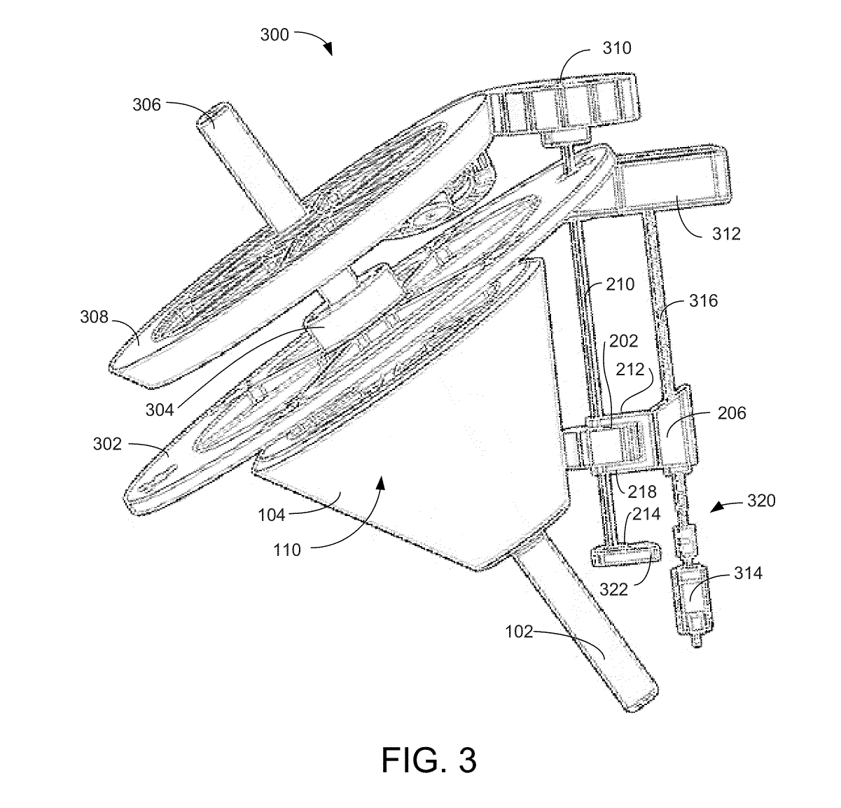

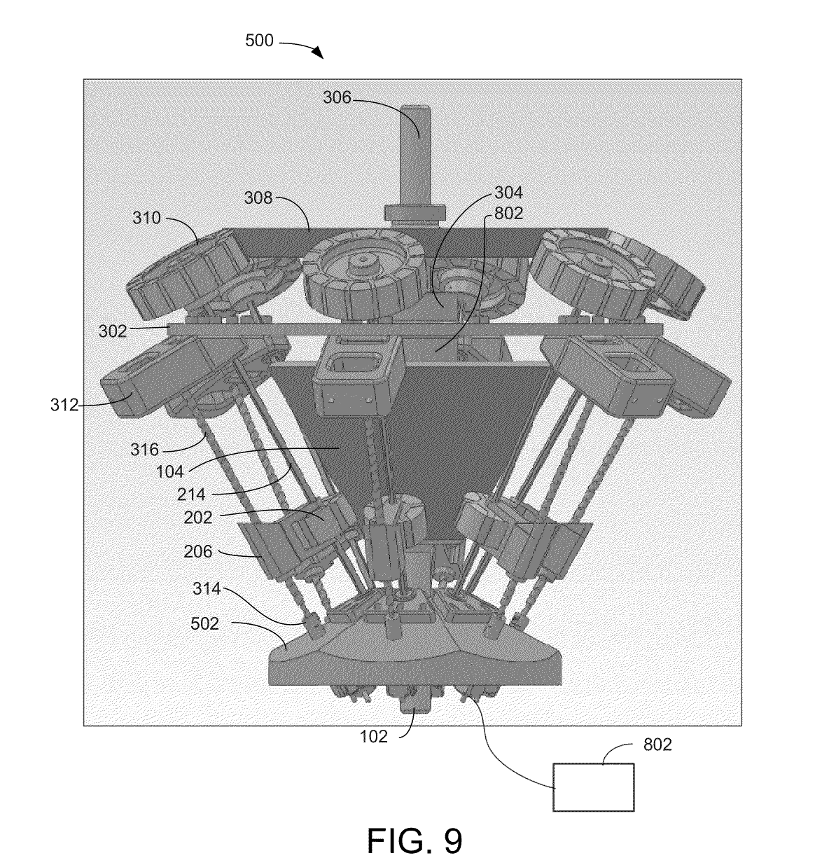

FIG. 3 is a perspective view illustrating an exemplary input drive shaft 102 and an exemplary magnetic torque cone 104 of FIG. 1; with the spline shaft 210, gear carriage 206, and magnetic drive gear 202 of FIG. 2; and gear carriage motor 314 and carriage ball screw 316 of the exemplary Magnetic Continuously Variable-Range Transmission 500 (See FIG. 5) of FIG. 1; as well as output magnetic planetary gears 308, 310 and output drive shaft 306, according to an exemplary embodiment 300 of the present invention. Support ring 302 does not rotate but connects to an environmental support (not shown) depending on the application. A bearing 304 is mounted on support ring 302 and rotationally receives an end of output shaft 306. Output shaft 306 is fixed to magnetic sun gear 308. Magnetic planetary gear 310 is fixed to and rotates with the spline shaft 210. That is, magnetic planetary gear 310 is driven by magnetic drive gear 202 which is magnetically torqued by magnetic torque cone 104. A plurality of magnetic planetary gears 310 drive magnetic sun gear 308 by magnetic torque action without direct contact and magnetic sun gear 308 drives output shaft 306. A bearing 902 (see FIG. 9) similar to bearing 304 is mounted under support ring 302 and rotationally receives an end of input shaft 102. Flanges 312 extend fixedly from support ring 302 and free rotationally receive an end of the all screw 316. Flanges 312 also serve to couple the Magnetic Continuously Variable-Range Transmission 500 to environmental supports, depending on the application, and to assist in free-rotation support of spline shafts 210.

To provide the variable speed ratios in the transmission the magnetic drive gear 202 is moved linearly along its spline shaft 210 with an actuator 320. In the example shown, actuator 320 includes a stepping motor 314 that rotates a ball screw 316. The ball screw 316 is engaged by a threaded bore in the carriage 206 coupled to the magnetic drive gear 202 so that when the ball screw 316 is turned the magnetic drive gear moves up or down the spline shaft 210. By keeping the ball screw 316 and magnetic drive gear 202 parallel, the magnetic drive gear 202 remains within the magnetic force area without touching components.

The drive mechanism 314, or stepping motor 314, is shown to be electrical. Hydraulic, pneumatic, or mechanical drive mechanisms 314 may also be used as the mechanical energy source. In a particular embodiment, the actuator 320 may hold the magnetic drive gear 202 to fit a particular application. Drive mechanism 314 is controlled through an appropriate control system to drive the magnetic drive gears 202 via the gear carriages 206 as needed. The control system may be manual or automatic. Control of a Magnetic Continuously Variable-Range Transmission 500 is via the control of the gear carriage stepping motors 314.

In embodiments having a magnetic drive cone with a constant density of magnets per square centimeter on the surface 110 of the magnetic torque cone 104, output torque is controlled with respect to the desired acceleration based on the input work supplied on input shaft 102. The output torque will depend, in part, on the load during acceleration. The Magnetic Continuously Variable-Range Transmission 500 will coast during instances of no output torque requirements. In a particular embodiment, the control system may define discrete positions for the magnetic drive gears 202 and change among those discrete positions based on the operational work performance of the source. For example, the gear ratio may shift (by changing discrete positions of the magnetic drive gears 202) when the input rotational speed reaches a pre-defined level, to imitate a traditional automotive automatic transmission.

In a particular embodiment, the Magnetic Continuously Variable-Range Transmission 500 comprises an internal brake which may be engaged or disengaged in response to control inputs.

All magnetic drive gears 202 move axially along spline shafts 210 in concert.

To disengage the Magnetic Continuously Variable-Range Transmission 500, you provide a portion free of magnets on the surface 110 of the magnetic torque cone 104 that the magnetic drive gear 202 would interact with. The magnet-free space would occur around a circumferential band on the surface 110 of the magnetic torque cone 104. Moving the magnetic drive gears 202, using the existing power mechanism 320, to the magnet-free zone, would disengage the transmission. In an alternate embodiment, the magnet-free zone may be off the magnetic torque cone 104 entirely, and disengagement may be achieved by moving the magnetic drive gears 202 off the magnetic torque cone 104. Support flange 322 supports bearing 214.

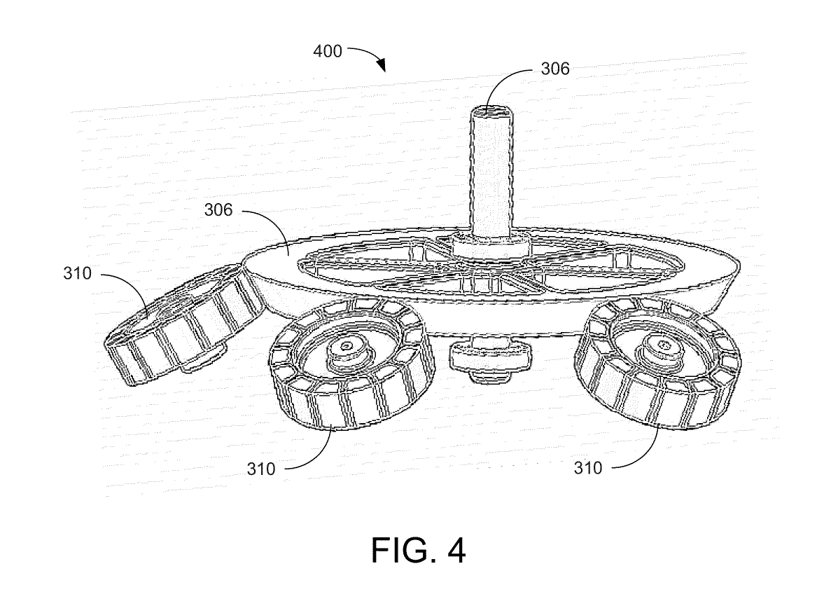

FIG. 4 is a perspective view illustrating a detail of an exemplary magnetic planetary gear 310 arrangement of the exemplary Magnetic Continuously Variable-Range Transmission 500 (See FIG. 5) of FIG. 1, according to an exemplary embodiment 400 of the present invention. The magnetically planetary gears 310 are attached to the spline shafts 210 in a manner that causes them to rotate at the same speed as the spline shaft 210. When the magnetic planetary gears 310 rotate they cause the magnetic sun gear 308 to rotate at a rate proportional to their diameters and drive the output shaft 306. The same magnetic mechanism as used in the torque cone gear 104 is applied to the proximate surfaces of the magnetic sun gear 306 and its magnetic planetary gears 310. Applying the same methods again removes the friction caused by normal gear teeth.

The quantity and diameters of each type of gears 104, 202, 310, and 308 determines the difference between the input shaft 102 and output shaft 306 speeds as well as torque. In a particular embodiment, the magnetic drive gear 202 may be placed within the internal envelope of the magnetic torque cone 104 for increased torque and reduced space requirements.

It is interesting to note that the output shaft 306 may be attached to more magnetic planetary gear systems or other designs to increase the gear ratio between input and output shafts. Also note that the input 102 and output shafts 306 may be reversed to speed up the rotation rate. Because of the non-contact nature of this device the gear ratio will not affect the ability to reverse directions as in standard friction-affected gears.

FIG. 5 is a shaded perspective view illustrating the exemplary Magnetic Continuously Variable-Range Transmission 500 of FIG. 1, according to an exemplary embodiment of the present invention. The exemplary Magnetic Continuously Variable-Range Transmission 500 uses six magnetic planetary gears 310, but that is not a limitation of the invention. Likewise, the size, cone angle, and specific size relationships are not limitations of the invention. Step motors 314 are supported by base support 502. Support flanges 322 are supported on base support 502 and support bearings 214 that rotationally receive spline shafts 210.

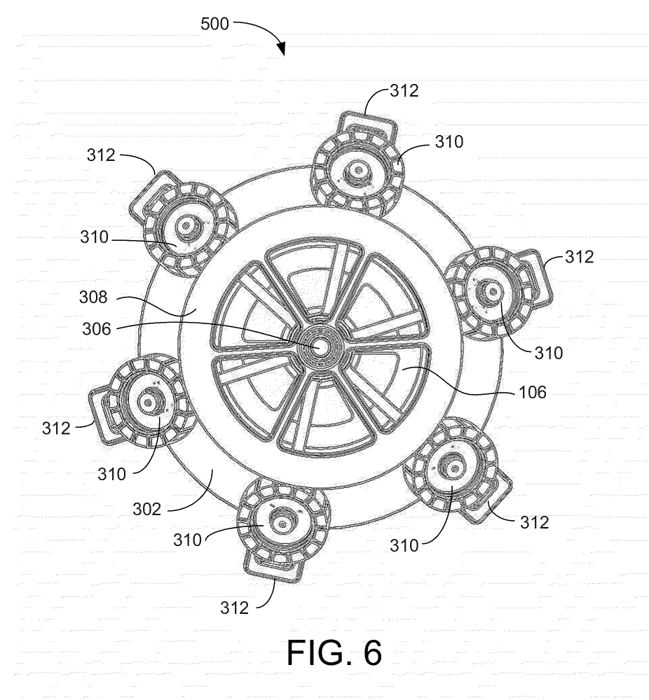

FIG. 6 is a top plan wire-frame view illustrating the exemplary Magnetic Continuously

Variable-Range Transmission 500 of FIG. 1, according to an exemplary embodiment of the present invention. Magnetic planetary gears 310 drive magnetic sun gear 308, which drives output shaft 306. Non-rotating support ring 302 supports flanges 312 and provides openings for spline shafts 210, which are free-rotationally supported by the flanges 312. Spline shafts 210 drive magnetic planetary gears 310 and are driven by magnetic drive gears 202. Magnetic drive gears 202 are driven by magnetic torque cone 104 which is driven by input shaft 102.

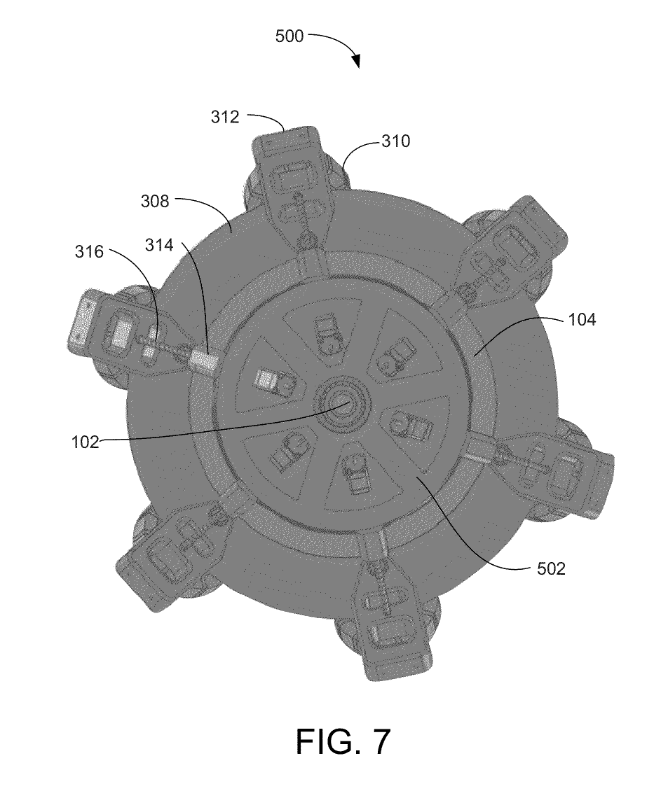

FIG. 7 is a bottom plan shaded view illustrating the exemplary Magnetic Continuously Variable-Range Transmission 500 of FIG. 1, according to an exemplary embodiment of the present invention.

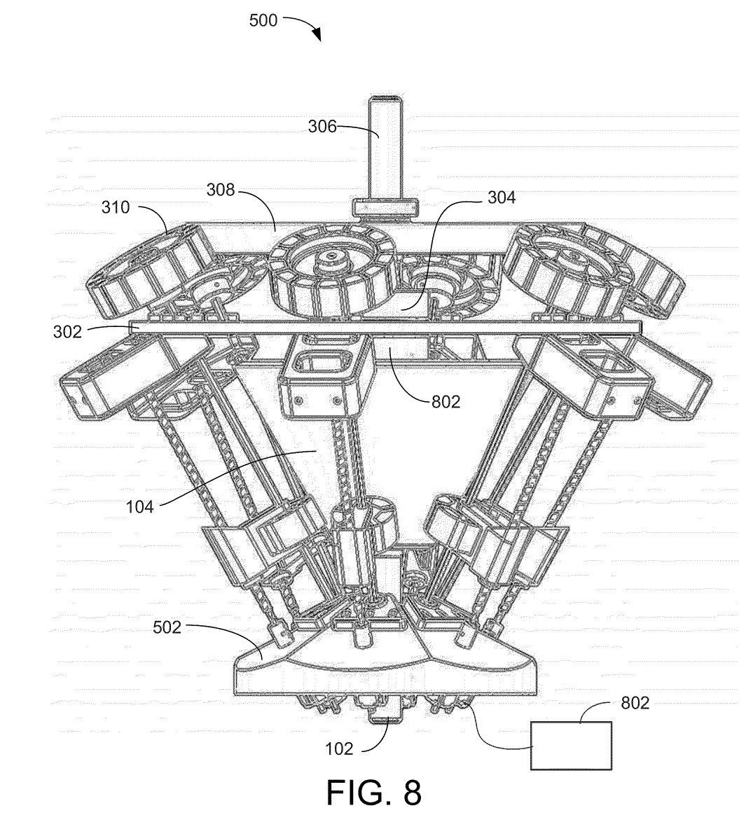

FIG. 8 is a side elevation wire-frame view illustrating the exemplary Magnetic Continuously Variable-Range Transmission 500 of FIG. 1, according to an exemplary embodiment of the present invention. Magnetic sun gear 308 is magnetically segmented, printed, or impressed. The magnetic planetary gears 310 are shown as segmented. Controller 802 is operable to command actuators 314 to move magnetic drive gears 202 axially along spline shafts 210 by rotating bail screws 316 to position gear carriage 206 and, therefore, magnetic drive gears 202, along the magnetic torque cone 110. The controller 802 may receive manual inputs directly from a user or may be part of a larger automatic system.

FIG. 9 is a side elevation shaded view illustrating the exemplary Magnetic Continuously Variable-Range Transmission 500 of FIG. 1, according to an exemplary embodiment of the present invention. This is a shaded version of the exemplary magnetic continuously variable-range transmission 500 of FIG. 8.

Magnetic materials that may be used within the transmission 500 include ferrite, ceramic, neodymium, samarium-cobalt, and others. The basic requirement is that the material holds its magnetic properties for the application over its lifespan.

Magnetic materials in proximity to electrically conductive materials generate eddy currents within the material. These currents will cause heating in the material and loss of magnetism if the material is a magnet. Examples of this include; two magnets moving past each other, a magnetic passing over a metallic bar. To counteract eddy currents magnets should be separated from interaction with other materials by separating with non-conductive spacers. Solid surface magnetic material should be broken into smaller pieces which are separated by non-conductive materials.

Magnets can be built up of multiple segments or a single segment with magnetic poles. In either case the north-south arrangement is made. Multiple arrayed magnets or impressed magnets are also acceptable when used to enhance a single magnet.

The application shown in FIG. 5 is just an example and not a requirement for this invention. Applications of this kind of transmission 500 include applications customized for automobiles, wind turbines, trucks, rolling mills, etc. as examples. Specifically, if you have a motive power that runs at a speed that is not optimum for the task, this transmission 500 can be used to adjust or modify the speed without the wear and tear of a standard geared transmission. As a result the magnetic transmission 500 will fit in a smaller space with lower cooling and wasted energy (heat) due to friction.

Those of skill in the art, enlightened by the present disclosure, will appreciate that a transmission using discrete, user-selectable, input-output gear ratios may also be built using magnetic torque systems. In fact, the novel magnetic gears of the present invention may be used in any application where toothed gears are used. Magnetic gears reduce the requirement for lubrication, cooling, and noise suppression.

I claim:

1. A magnetic continuously variable-range transmission, comprising:
a. a magnetic torque cone, comprising a frustrum of a cone having a first magnetic surface, a central axis, and a drive shaft, wherein said cone is mounted on said drive shaft and operable to be rotationally driven about said central axis by said drive shaft; and
b. a plurality of magnetic drive gears each having a second magnetic circumferential surface and positionable to be magnetically but not mechanically engaged with said magnetic torque cone such that said rotation of said magnetic torque cone is operable to drive said magnetic drive gears to rotate.

2. The transmission of claim 1, wherein said first magnetic surface comprises a first predetermined pattern of magnets and said second magnetic surface comprises a second predetermined pattern of magnets.

3. The transmission of claim 1, wherein said first magnetic surface has a first predetermined pattern of magnets operable to provide a constant-torque transmission.

4. The transmission of claim 1, wherein said first magnetic surface comprises a non-magnetic circumferential band.

5. The transmission of claim 1, further comprising a spline shaft mounted axially slidingly in each magnetic drive gear of said plurality of magnetic drive gears and fixed spaced-apart and parallel to said first magnetic surface, wherein each said spline shaft is operable to be rotationally driven by rotation of each said magnetic drive gear, respectively.

6. The transmission of claim 5, further comprising an actuator for each said magnetic drive gear operable to position each said magnetic drive gear, respectively, axially along each respective said spline shaft.

7. The transmission of claim 6, further comprising a controller operable to command each said actuator to position each said magnetic drive gear.

8. The transmission of claim 5, further comprising a magnetic planetary gear having a third magnetic circumferential surface and mounted fixedly and axially on each said spline shaft and operable to be driven by each said spline shaft, respectively.

9. The transmission of claim 8, further comprising a magnetic sun gear having a fourth magnetic circumferential surface and magnetically but not mechanically engaged with each said planetary gear, wherein said magnetic sun gear is operable to be rotationally driven by each said planetary gear and to drive an output shaft.

10. The transmission of claim 1, wherein said third magnetic surface comprises a third predetermined pattern of magnets and said fourth magnetic surface comprises a fourth predetermined pattern of magnets.

11. A magnetic continuously variable-range transmission, comprising:
a. a magnetic torque cone, comprising a frustrum of a cone having a first magnetic surface, a central axis, and a drive shaft, wherein said cone is mounted on said drive shaft and operable to be rotationally driven about said central axis by said drive shaft; and
b. a plurality of magnetic drive gears each having a second magnetic circumferential surface and positionable to be magnetically but not mechanically engaged with said magnetic torque cone such that said rotation of said magnetic torque cone is operable to drive said magnetic drive gears to rotate; and
c. a spline shaft mounted axially slidingly in each magnetic drive gear of said plurality of magnetic drive gears and fixed spaced-apart and parallel to said first magnetic surface, wherein each said spline shaft is operable to be rotationally driven by rotation of each said magnetic drive gear, respectively;
d. wherein said first magnetic surface comprises a first predetermined pattern of magnets and said second magnetic surface comprises a second predetermined pattern of magnets.

12. The transmission of claim 11, wherein said first magnetic surface has a first predetermined pattern of magnets operable to provide a constant-torque transmission.

13. The transmission of claim 11, wherein said first magnetic surface comprises a non-magnetic circumferential band.

14. The transmission of claim 11, further comprising an actuator for each said magnetic drive gear operable to position each said magnetic drive gear, respectively, axially along each respective said spline shaft.

15. The transmission of claim 14, further comprising a controller operable to command each said actuator to position each said magnetic drive gear.

16. The transmission of claim 14, further comprising a magnetic planetary gear having a third magnetic circumferential surface and mounted fixedly and axially on each said spline shaft and operable to be driven by each said spline shaft, respectively.

17. The transmission of claim 16, further comprising a magnetic sun gear having a fourth magnetic circumferential surface and magnetically but not mechanically engaged with each said planetary gear, wherein said magnetic sun gear is operable to be rotationally driven by each said planetary gear and to drive an output shaft.

18. The transmission of claim 17, wherein said third magnetic surface comprises a third predetermined pattern of magnets and said fourth magnetic surface comprises a fourth predetermined pattern of magnets.

19. A magnetic continuously variable-range transmission, comprising:
a. a magnetic torque cone, comprising a frustrum of a cone having a first magnetic surface, a central axis, and a drive shaft, wherein:
i. said cone is mounted on said drive shaft and operable to be rotationally driven about said central axis by said drive shaft; and
ii. said first magnetic surface comprises a first predetermined pattern of magnets
b. a plurality of magnetic drive gears each having a second magnetic circumferential surface and positionable to be magnetically but not mechanically engaged with said magnetic torque cone such that said rotation of said magnetic torque cone is operable to drive said magnetic drive gears to rotate, wherein said second magnetic surface comprises a second predetermined pattern of magnets;
c. wherein said first predetermined pattern of magnets comprises at least one of:
i. said first predetermined pattern of magnets operable to provide a constant-torque transmission; and
ii. a non-magnetic circumferential band, operable to magnetically disengage said plurality of magnetic drive gears;
d. a spline shaft mounted axially sliding in each magnetic drive gear of said plurality of magnetic drive gears and fixed spaced-apart and parallel to said first magnetic surface, wherein each said spline shaft is operable to be rotationally driven by rotation of each said magnetic drive gear, respectively; and
e. an actuator for each said drive wheel operable to position each said drive wheel, respectively, axially along each respective said spline shaft;
f. a magnetic planetary gear having a third magnetic circumferential surface and mounted fixedly and axially on each said spline shaft and operable to be driven by each said spline shaft, respectively, wherein said third magnetic surface comprises a third predetermined pattern of magnets;
g. a magnetic sun gear having a fourth magnetic circumferential surface and magnetically but not mechanically engaged with each said planetary gear, wherein said magnetic sun gear is operable to be rotationally driven by each said planetary gear and to drive an output shaft, wherein said fourth magnetic surface comprises a fourth predetermined pattern of magnets;

20. The transmission of claim 19, further comprising a controller operable to command each said actuator to position each said magnetic drive gear.
